(19) United States
(12) Patent Application Publication
(10) Pub. No.: US 2022/0285871 A1
(43) Pub. Date: Sep. 8, 2022

(54) FEMALE TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Seido NISHIJIMA, Mie (JP); Katsuhiko AIZAWA, Mie (JP); Kyohei IDA, Mie (JP)

(21) Appl. No.: 17/633,308

(22) PCT Filed: Jul. 20, 2020
(86) PCT No.: PCT/JP2020/028119

§ 371 Date: Feb. 7, 2022

(30) Foreign Application Priority Data
Aug. 9, 2019 (JP) 2019-148062
Nov. 15, 2019 (JP) 2019-207367

(51) Int. Cl. H01R 13/18; H01R 13/11; H01R 13/20

(52) U.S. Cl. CPC H01R 13/18; H01R 13/11; H01R 13/20

(57) ABSTRACT

It is aimed to provide a female terminal of a novel structure having a large degree of freedom in setting a pressure contact force between a male terminal including a columnar connecting portion and a female terminal including a tubular connecting portion and capable of stably ensuring a large contact area between the male and female terminals. A female terminal 10 includes a tubular connecting portion 24 having a first peripheral wall portion 12 and a second peripheral wall portion 14 arranged to face each other and to be conductively connected to a cylindrical connecting portion 22 of a male terminal 20, a biasing means 64 for biasing the first and second peripheral wall portions 12, 14 in directions approaching each other, and an arcuate protrusion 34 provided on an inner surface 18 having an arcuate cross-section of at least one of the first and second peripheral wall portions 12, 14 and projecting radially inward while extending in a circumferential direction of the inner surface 18. The first and second peripheral wall portions 12, 14 are separably displaceable against a biasing force of the biasing means 64.

### TECHNICAL FIELD

The present disclosure relates to a female terminal including a tubular connecting portion to be conductively connected to a columnar connecting portion of a male terminal.

### BACKGROUND

Conventionally, there is used an electrical connection structure by a male terminal including a substantially cylindrical columnar connecting portion called a pin terminal or the like and a female terminal including a substantially hollow cylindrical tubular connecting portion called a sleeve terminal or the like. A structure for holding a contact state between the male and female terminals is adopted inside the tubular connecting portion of the female terminal. For example, in a female terminal described in Japanese Patent Laid-open Publication No. 2016-024901 (Patent Document 1), a resilient contact piece folded rearward from a tip opening is provided inside a tubular connecting portion. By a resilient restoring force of this resilient contact piece, an end part of the resilient contact piece is pressed against a columnar connecting portion of a male terminal, whereby the male terminal and the female terminal are held in a contact state to establish an electrical connection.

### PRIOR ART DOCUMENT

### Patent Document

Patent Document 1: JP 2016-024901 A

### SUMMARY OF THE INVENTION

### Problems to be Solved

In such a female terminal having a conventional structure, the end part of the resilient contact piece is pressed against the columnar connecting portion of the male terminal, whereby the male and female terminals are held in the contact state. Thus, a degree of freedom in setting a pressure contact force of the resilient contact piece toward the male terminal is small and it has been difficult in some cases to bring the male and female terminals into contact with each other with a contact pressure of a required magnitude. Further, since the end part side of the resilient contact piece is pressed into contact with the male terminal side, the problem has been that it is difficult to stably ensure a large contact area between the male and female terminals.

Accordingly, it is aimed to provide a female terminal of a novel structure having a large degree of freedom in setting a pressure contact force between a male terminal including a columnar connecting portion and a female terminal including a tubular connecting portion and capable of stably ensuring a large contact area between the male and female terminals.

### Means to Solve the Problem

The present disclosure is directed to a female terminal with a tubular connecting portion including a first peripheral wall portion and a second peripheral wall portion arranged to face each other, the tubular connecting portion being conductively connected to a columnar connecting portion of a male terminal, a biasing means for biasing the first and second peripheral wall portions in directions approaching each other, and an arcuate protrusion provided on an inner surface having an arcuate cross-section of at least one of the first and second peripheral wall portions, the arcuate protrusion projecting radially inward while extending in a circumferential direction of the inner surface, the first and second peripheral wall portions being separably displaceable against a biasing force of the biasing means.

### Effect of the Invention

According to the present disclosure, it is possible to provide a female terminal having a large degree of freedom in setting a pressure contact force of a tubular connecting portion of a female terminal to a columnar connecting portion of a male terminal and capable of stably ensuring a large contact area.

### BRIEF DESCRIPTION OF THE DRAWINGS

FIG. 1 is a perspective view showing a female terminal according to a first embodiment.

FIG. 2 is a plan view of the female terminal shown in FIG. 1.

FIG. 3 is a bottom view of the female terminal shown in FIG. 1.

FIG. 4 is a section along IV-IV in FIG. 2.

FIG. 5 is a section of a female terminal fitting shown in FIG. 4 showing a state before a pair of overlapping plate portions are biased by a biasing means.

FIG. 6 is an enlarged view in section along VI-VI in FIG. 2.

FIG. 7 is a perspective view showing a female terminal according to a second embodiment.

FIG. 8 is a section along VIII-VIII in FIG. 7.

FIG. 9 is a section of a female terminal fitting shown in FIG. 8 showing a state before a pair of overlapping plate portions are biased by a biasing means.

FIG. 10 is an enlarged view in section along X-X in FIG. 7.

FIG. 11 is a perspective view showing a female terminal according to a third embodiment.

FIG. 12 is a section along XII-XII in FIG. 11.

FIG. 13 is a section of a female terminal fitting shown in FIG. 12 showing a state before a pair of overlapping plate portions are biased by a biasing means.

FIG. 14 is a perspective view showing a female terminal according to a fourth embodiment.

FIG. 15 is a plan view of the female terminal shown in FIG. 14.

FIG. 16 is a section along XVI-XVI in FIG. 15.

FIG. 17 is an enlarged view in section along XVII-XVII in FIG. 15.

### DETAILED DESCRIPTION TO EXECUTE THE INVENTION

[Description of Embodiments of Present Disclosure]

First, embodiments of the present disclosure are listed and described.

(1) The female terminal of the present disclosure is provided with a tubular connecting portion including a first peripheral wall portion and a second peripheral wall portion arranged to face each other, the tubular connecting portion being conductively connected to a columnar connecting portion of a male terminal, a biasing means for biasing the first and second peripheral wall portions in directions approaching each other, and an arcuate protrusion provided on an inner surface having an arcuate cross-section of at least one of the first and second peripheral wall portions, the arcuate protrusion projecting radially inward while extending in a circumferential direction of the inner surface, the first and second peripheral wall portions being separably displaceable against a biasing force of the biasing means.

According to the female terminal of the present disclosure, the tubular connecting portion to be conductively connected to the columnar connecting portion of the male terminal includes the first and second peripheral wall portions arranged to face each other. The first and second peripheral wall portions are biased in the directions approaching each other by the biasing means, and are separably displaceable from each other against the biasing force. Accordingly, when the columnar connecting portion of the male terminal is press-fit into the tubular connecting portion of the female terminal, the first and second peripheral wall portions are separably displaced from each other against the biasing force of the biasing means to allow the columnar connecting portion to be press-fit into the tubular connecting portion. After the press-fitting of the columnar connecting portion of the male terminal, the first and second peripheral wall portions of the tubular connecting portion of the female terminal are maintained in a state biased in the directions approaching each other by the biasing force of the biasing means. Thus, a pressure contact state between the male and female terminals can be stably maintained. Particularly, since a pressure contact force of the tubular connecting portion of the female terminal to the columnar connecting portion of the male terminal can be arbitrarily set by adjusting the biasing means for biasing the first and second peripheral wall portions in the approaching directions, the pressure contact force between the male and female terminals can be set with a large degree of freedom.

Moreover, at least one of the first and second peripheral wall portions has the inner surface having the arcuate cross-section, and the arcuate protrusion projecting radially inward while extending in the circumferential direction of the inner surface is provided on this inner surface. Thus, the arcuate protrusion can be pressed into contact with a wide range of the outer peripheral surface of the columnar connecting portion of the male terminal press-fit into the tubular connecting portion of the female terminal with a high contact pressure, and a wide contact area between the male and female terminals can be stably ensured. Particularly, if the male terminal includes a cylindrical connecting portion, a more wide and stable contact area can be ensured. Further, since the arcuate protrusion projecting radially inward while extending in the circumferential direction of the inner surface is provided on this inner surface of at least one of the first and second peripheral wall portions, a peak of an insertion force is produced by the arcuate protrusion during an operation of inserting the columnar connecting portion of the male terminal into the tubular connecting portion of the female terminal. In this way, when the male terminal is inserted to a back side beyond the arcuate protrusion, a worker can feel that the peak of the insertion force has been passed and an insertion completion position has been reached and detect the proper connection of the male and female terminals.

(2) Preferably, both the first and second peripheral wall portions have the inner surface having the arcuate cross-section, and the arcuate protrusion is provided on each of the inner surfaces of the both first and second peripheral wall portions. This is because the tubular connecting portion of the female terminal can be stably brought into contact with the outer peripheral surface of the columnar connecting portion of the male terminal with a wider contact area.

(3) In (1) described above, preferably, both the first and second peripheral wall portions have the inner surface having the arcuate cross-section, the arcuate protrusion is provided on the inner surface of one of the first and second peripheral wall portions, and linear connecting portions projecting radially inward while extending in an axial direction of the inner surface are provided at a plurality of positions separated in the circumferential direction on the inner surface of the other of the first and second peripheral wall portions. The linear connecting portions projecting on the inner surface of the other of the first and second peripheral wall portions and extending in the axial direction are pressed into line contact with the columnar connecting portion of the male terminal at the plurality of positions separated in the circumferential direction. In this way, even if a swinging motion is transmitted to the male terminal from a wire, a swinging displacement of the male terminal can be hindered by the contact of the male terminal with the plurality of linear connecting portions. Therefore, a swinging displacement of the male terminal can be hindered by the linear connecting portions of the other of the first and second peripheral wall portions while the arcuate protrusion of the one of the first and second peripheral wall portions is pressed into contact with a wide range of the outer peripheral surface of the columnar connecting portion of the male terminal with a high contact pressure, and both an increase in contact area with the male terminal and stable holding of the male terminal can be achieved. Note that a plurality of linear connecting portions may be provided in regions separated from the arcuate protrusion in the axial direction on the inner surface of the one of the first and second peripheral wall portions, and an arcuate protrusion may be provided in a region separated from the plurality of linear connecting portions in the axial direction on the inner surface of the other of the first and second peripheral wall portions.

(4) In (3) described above, preferably, a curvature of the other of the first and second peripheral wall portions is set smaller than that of the outer peripheral surface of the columnar connecting portion of the male terminal. This is because, by setting the curvature of the other of the first and second peripheral wall portions smaller than that of the outer peripheral surface of the columnar connecting portion of the male terminal, the plurality of linear connecting portions can be reliably brought into contact with the columnar connecting portion of the male terminal and a more stable effect of hindering a swinging displacement of the male terminal by the linear connecting portions can be obtained.

(5) Preferably, the arcuate protrusion extends in the circumferential direction to have a circumferential length of ⅔ or more of a circumferential length of the inner surface. This is because the tubular connecting portion of the female terminal can be stably brought into contact with the outer peripheral surface of the columnar connecting portion of the male terminal with a sufficiently wide contact area.

(6) Preferably, a side surface of the arcuate protrusion facing a male terminal insertion opening side of the tubular connecting portion has an arcuate cross-section. A sudden increase of insertion resistance in inserting a cylindrical connecting portion of the male terminal into the tubular connecting portion of the female terminal can be suppressed and insertion easiness can be improved. Note that both side surfaces of the arcuate protrusion preferably have an arcuate cross-section. This is because the directionality of the tubular connecting portion of the female terminal can be eliminated.

(7) Preferably, a pair of overlapping plate portions separated from each other and projecting outward are respectively connected to a pair of mutually facing first peripheral end parts of the first and second peripheral wall portions, and the biasing means biases the pair of overlapping plate portions in directions to overlap the overlapping plate portions each other, whereby the first and second peripheral wall portions are biased in directions approaching each other. Since the overlapping plate portions may respectively project on the respective peripheral end parts of the first and second peripheral wall portions and be biased in the directions to be overlapped each other, a location where the biasing means is mounted can be stably secured. As a result, a degree of freedom in selecting the biasing means can be improved.

(8) Preferably, a female terminal fitting is provided which includes the tubular connecting portion on one end side and a wire connecting portion on the other end side, and the biasing means is held on the female terminal fitting. Since the female terminal fitting is integrally provided with the tubular connecting portion and the wire connecting portion, the number of components of the female terminal can be reduced. Further, since the biasing means is also held on the female terminal fitting, a pressure contact force between the male and female terminals can be stably provided while the handleability of the female terminal is improved.

[Details of Embodiments of Present Disclosure]

Specific examples of a female terminal of the present disclosure are described below with reference to the drawings. Note that the present disclosure is not limited to these illustrations and is intended to be represented by claims and include all changes in the scope of claims and in the meaning and scope of equivalents.

### First Embodiment

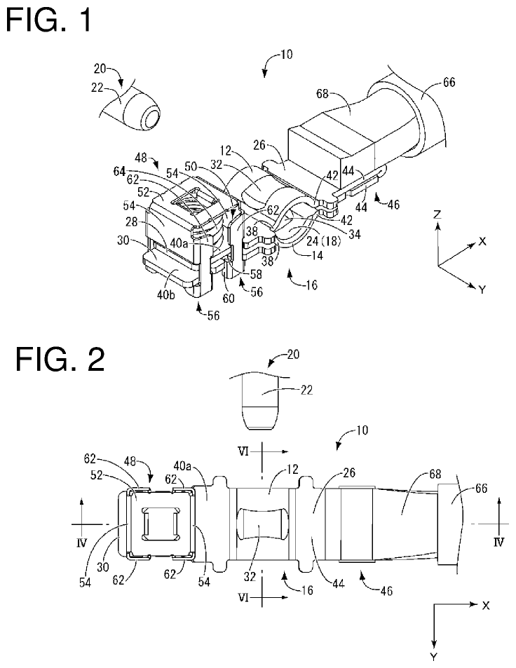

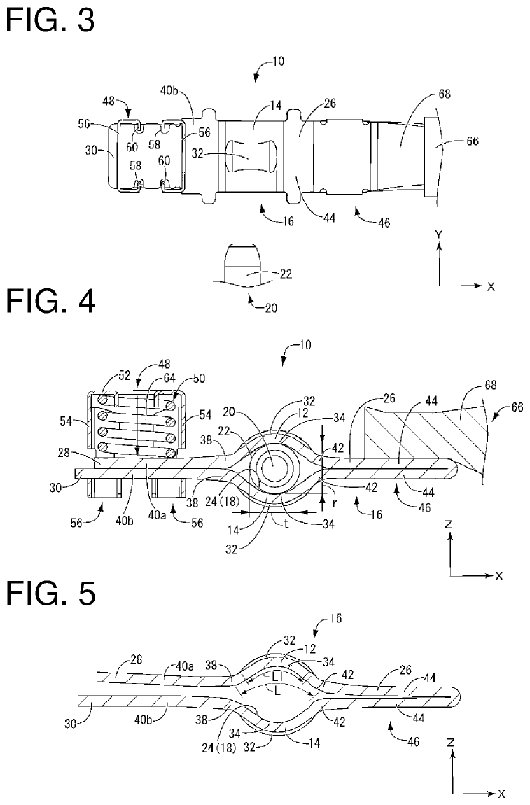

Hereinafter, a first embodiment of the present disclosure is described with reference to FIGS. 1 to 6. FIGS. 1 to 6 show a female terminal 10 according to the first embodiment of the present disclosure. The female terminal 10 includes a female terminal fitting 16 having a first peripheral wall portion 12 and a second peripheral wall portion 14 arranged to face each other. The female terminal fitting 16 is formed with a tubular connecting portion 24 to be conductively connected to a cylindrical connecting portion 22 of a male terminal 20 having a substantially cylindrical pin shape by inner surfaces 18 of the first and second peripheral wall portions 12, 14. Note that, in the following description, a Z direction, a Y direction and an X direction are referred to as an upward direction, a width direction and a length direction. Further, for a plurality of identical members, only some members may be denoted by a reference sign and the other members may not be denoted by the reference sign.

<First Peripheral Wall Portion 12 and Second Peripheral Wall Portion 14>

As shown in FIGS. 1 and 4, the female terminal fitting 16 is formed by press-working a strip-like metal flat plate 26 into a predetermined shape. A metal having a low electrical resistance such as copper, copper alloy, aluminum or aluminum alloy can be appropriately selected as a metal constituting the metal flat plate 26. In this embodiment, one end part in a length direction of the strip-like metal flat plate 26 is folded in two to be overlapped on another end part 30 (left side in FIG. 4). Intermediate parts in the length direction of overlapping surfaces are curved in directions separating from each other with the one end part 28 overlapped on the other end part 30, whereby the substantially hollow cylindrical tubular connecting portion 24 is formed. The tubular connecting portion 24 is open on both widthwise sides and has a maximum inner diameter r smaller than a maximum outer diameter t of the male terminal 20. That is, the tubular connecting portion 24 is configured such that the male terminal 20 is press-fit thereinto.

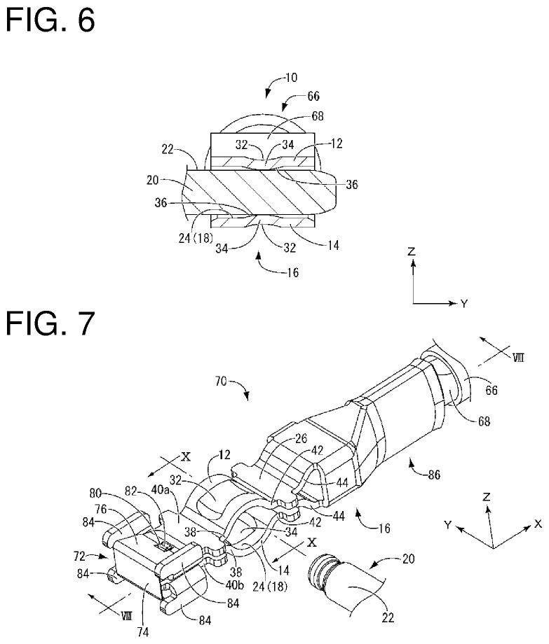

As shown in FIGS. 1 to 6, recesses 32 having a rectangular cross-sectional shape in a plan or bottom view are provided in widthwise central parts of the outer surfaces of the both first and second peripheral wall portions 12, 14. Arcuate protrusions 34 projecting radially inward in arcuate lengthwise cross-section (see FIG. 4) and widthwise cross-section (see FIG. 6) are provided on the both inner surfaces 18 of the first and second peripheral wall portions 12, 14. That is, both the first and second peripheral wall portions 12, 14 have the inner surface 18 having an arcuate cross-section, and the arcuate protrusions 34 projecting radially inward while extending in a circumferential direction of the inner surfaces 18 are provided on the inner surfaces 18. For example, as shown in FIG. 5, the arcuate protrusion 34 extends in the circumferential direction to have a circumferential length L1, which is ⅔ or more of an entire circumferential length L of the inner surface 18. Note that L1/L is approximately ⅘ in this embodiment. Moreover, as shown in FIG. 6, both side surfaces 36, 36 of the arcuate protrusion 34 facing a male terminal insertion opening side of the tubular connecting portion 24 have an arcuate cross-section. Therefore, an insertion resistance change can be made similar regardless of on which of left and right sides the male terminal insertion opening to the tubular connecting portion 24 is set, and the directionality of the female terminal 10 can be reduced. Note that although the male terminal insertion opening is on the left side in FIG. 6, the male terminal 20 can also be inserted from the right side.

The tubular connecting portion 24 is formed by the first and second peripheral wall portions 12, 14 arranged to face each other. In this way, for example, as shown in FIG. 5, a pair of overlapping plate portions 40a, 40b projecting outward (leftward in FIG. 5) while being separated from each other are respectively connected to a pair of mutually facing first peripheral end parts 38, 38 of the first and second peripheral wall portions 12, 14. Further, a pair of second peripheral end parts 42, 42 are formed at another circumferential position facing the pair of first peripheral end parts 38, 38 in a radial direction of the first and second peripheral wall portions 12, 14. The pair of second peripheral end parts 42, 42 are provided with a pair of extending plate portions 44, 44 connected to the pair of second peripheral end parts 42, 42 and projecting outward (rightward in FIG. 5). A wire connecting portion 46 is configured by overlapping the pair of extending plate portions 44, 44 each other.

<Case 48>

A case 48 is assembled with the pair of overlapping plate portions 40a, 40b (see, for example, FIG. 1). The case 48 is formed using one of various metal materials, which can be press-worked or punched, such as brass, copper, copper alloy, aluminum, aluminum alloy and stainless steel. The case 48 is so assembled with the female terminal fitting 16 that an accommodation space 50 is disposed above one 40a of the pair of overlapping plate portions 40a, 40b of the female terminal fitting 16. More particularly, in an assembled state, the case 48 includes a facing wall 52 substantially in the form of a rectangular flat plate facing the one 40a of the pair of overlapping plate portions 40a, 40b via the accommodation space 50. Further, the case 48 includes a pair of wall portions 54, 54 substantially in the form of rectangular flat plates extending downward from both side edge parts in the length direction of the facing wall 52, and the accommodation space 50 is configured by the facing wall 52 and the pair of wall portions 54, 54. Furthermore, the case 48 is provided with engaging frame bodies 56 having a U shape, projecting downward and to be engaged with the lower surface of the overlapping plate portion 40b on both widthwise sides of extending end parts of the pair of wall portions 54, 54. Further, engaging projections 60 to be engaged with engaging recesses 58 having an L shape, projecting inward in the width direction and formed on both widthwise sides of the overlapping plate portion 40b are provided on both widthwise sides of the engaging frame bodies 56. Further, coil spring holding walls 62 in the form of rectangular flat plates projecting toward the facing wall portions 54 are provided on both side edge parts of the extending end parts of the pair of wall portions 54, 54 (see, for example, FIG. 1).

The case 48 is held on the one 40a of the pair of overlapping plate portions 40a, 40b with a coil spring 64 made of metal, which is a spring member constituting a biasing means, accommodated and arranged in the accommodation space 50 (see, for example, FIG. 1). That is, with the coil spring 64 arranged in the accommodation space 50 of the case 48, the case 48 is arranged to be placed above the one 40a of the pair of overlapping plate portions 40a, 40b of the female terminal fitting 16. Subsequently, the engaging projections 60 of the case 48 are bent inward in the width direction to be engaged with the engaging recesses 58 provided in the side edge parts of the overlapping plate portion 40b. In this way, the extending end parts of the pair of wall portions 54, 54 of the case 48 are fixed to the other 40b of the pair of overlapping plate portions 40a, 40b while being placed on the one 40a of the pair of overlapping plate portions 40a, 40b. That is, the coil spring 64 accommodated in the case 48 is indirectly held on the female terminal fitting 16. In this state, the coil spring 64 is held in a compressed state between the one 40a of the pair of overlapping plate portions 40a, 40b and the facing wall 52 of the case 48. The pair of overlapping plate portions 40a, 40b are biased in directions (directions of arrows in FIG. 4) approaching each other by this coil spring 64 held in the compressed state. That is, the coil spring 64 serving as the biasing means biases the pair of overlapping plate portions 40a, 40b in directions to overlap the overlapping plate portions 40a, 40b each other, whereby the first and second peripheral wall portions 12, 14 can be biased in directions approaching each other and separably displaced against a biasing force of the coil spring 64.

<Wire Connecting Portion 46>

On the other hand, the pair of extending plate portions 44, 44 are fixed to and integrated with each other using a known arbitrary means such as resistance welding. Note that the pair of extending plate portions 44, 44 in a state overlapped each other constitute the wire connecting portion 46, and work efficiency can be improved by welding the extending plate portions 44, 44 to each other simultaneously when a core 68 of a wire 66 is welded to the wire connecting portion 46. As a result, the female terminal fitting 16 is conductively connected to the core 68 of the wire 66 in the wire connecting portion 46.

Next, functions and effects of this embodiment are described. According to this embodiment, the tubular connecting portion 24 to be conductively connected to the cylindrical connecting portion 22 of the male terminal 20 having a substantially cylindrical pin shape is configured in the female terminal fitting 16 by the inner surfaces 18 of the first and second peripheral wall portions 12, 14. Further, the first and second peripheral wall portions 12, 14 are biased in the directions approaching each other by the coil spring 64 serving as the biasing means, and can be separably displaced against a biasing force of the coil spring 64. That is, when the cylindrical connecting portion 22 of the male terminal 20 is press-fit into the tubular connecting portion 24 of the female terminal 10, the first and second peripheral wall portions 12, 14 are separably displaced from each other against the biasing force of the coil spring 64, thereby allowing the male terminal 20 to be press-fit into the female terminal 10. Further, after press-fitting, the first and second peripheral wall portions 12, 14 constituting the tubular connecting portion 24 of the female terminal 10 are maintained in a state biased in the directions approaching each other by the biasing force of the coil spring 64. Therefore, a pressure contact state between the female terminal 10 and the male terminal 20 can be stably maintained. Note that since a pressure contact force between the female terminal 10 and the male terminal 20 can be arbitrarily set by adjusting the coil spring 64 for biasing the first and second peripheral wall portions 12, 14 in the approaching directions, the pressure contact force between the female terminal 10 and the male terminal 20 can be set with a large degree of freedom.

Further, both the first and second peripheral wall portions 12, 14 have the inner surface 18 having an arcuate cross-section, and the arcuate protrusions 34 projecting radially inward while extending in the circumferential direction of the inner surfaces 18 are provided on the inner surfaces 18. Thus, the outer peripheral surface of the cylindrical connecting portion 22 of the male terminal 20 press-fit between the first and second peripheral wall portions 12, 14 constituting the tubular connecting portion 24 of the female terminal 10 can be pressed into contact with the arcuate protrusions 34 in a wide range and with a high contact pressure. In this way, a wide contact area between the female terminal 10 and the male terminals 20 can be stably ensured. Further, in this embodiment, the arcuate protrusion 34 extends in the circumferential direction to have the circumferential length L1, which is approximately ⅘ of the entire circumferential length of the inner surface 18. Therefore, the inner surfaces 18 of the first and second peripheral wall portions 12, 14 can be stably brought into contact with the outer peripheral surface of the cylindrical connecting portion 22 of the male terminal 20 with a sufficiently wide contact area.

Further, the side surfaces 36 of the arcuate protrusions 34 facing the male terminal insertion opening sides of the first and second peripheral wall portions 12, 14 constituting the tubular connecting portion 24 of the female terminal 10 are formed to have an arcuate cross-section. In this way, the maximum inner diameter r of the tubular connecting portion 24, into which the cylindrical connecting portion 22 of the male terminal 20 is inserted, is gradually reduced in an inserting direction. Thus, a sudden increase of insertion resistance in press-fitting a cylindrical connecting portion into a tubular connecting portion having a small diameter as before can be suppressed and insertion easiness can be improved. Note that since the side surfaces 36 of the arcuate protrusions 34 facing the male terminal insertion opening side of the tubular connecting portion 24 are formed to have an arcuate cross-section, insertion directionality in the width direction of the tubular connecting portion 24 of the female terminal 10 can be eliminated. Further, since the arcuate protrusions 34, 34 are provided, a worker actually feels a peak of an insertion force by first inserting the cylindrical connecting portion 22 of the male terminal 20 between the arcuate protrusions 34, 34 in an operation of inserting the cylindrical connecting portion 22 of the male terminal 20 into the tubular connecting portion 24 of the female terminal 10 as shown in FIG. 6. Thereafter, by further pushing the cylindrical connecting portion 22 to a back side (right side in FIG. 6) beyond the arcuate protrusions 34, 34, the worker can feel that the peak of the insertion force has been passed and an insertion completion position has been reached, whereby an additional effect of being able to detect the proper connection of the male terminal 20 and the female terminal 10 is also exhibited.

In addition, the pair of flat plate-like overlapping plate portions 40a, 40b respectively project outward from the pair of mutually facing first peripheral end parts 38, 38 of the first and second peripheral wall portions 12, 14 and are biased in the directions to be overlapped each other. At this time, since the coil spring 64 serving as the biasing means is mounted on the pair of flat plate-like overlapping plate portions 40a, 40b overlapped each other, a location where the coil spring 64 is mounted can be stably secured and a degree of freedom in selecting the coil spring 64 can be improved.

### OTHER EMBODIMENTS

The technique described in this specification is not limited to the above described and illustrated embodiment. For example, the following embodiments are also included in the technical scope of the technique described in this specification.

(1) Although the coil spring 64 accommodated in the case 48 is described as an example of the biasing means in the first embodiment, there is no limitation to this. The biasing means may be constituted by a clip 72 as in a female terminal 70 of a second embodiment of the present disclosure shown in FIGS. 7 to 10. Specifically, the clip 72 is formed using a strip plate made of one of various metal materials, which can be press-worked or punched, such as spring steel, stainless steel, brass, phosphor bronze and beryllium copper. The clip 72 includes a coupling plate portion 74 in the form of a rectangular flat plate and a pair of sandwiching plate portions 76, 76 in the form of rectangular flat plates projecting in directions to approach each other from both side edge parts of the coupling plate portion 74. Projecting end parts of the pair of sandwiching plate portions 76, 76 are slightly bent in directions separating from each other. A clearance between the closest parts of the projecting end parts of the pair of sandwiching plate portions 76, 76 serves as an insertion opening 78. Lock holes 80 having a rectangular cross-sectional shape are provided to penetrate in a plate thickness direction through the pair of sandwiching plate portions 76, 76 in a substantially central part of the insertion opening 78.

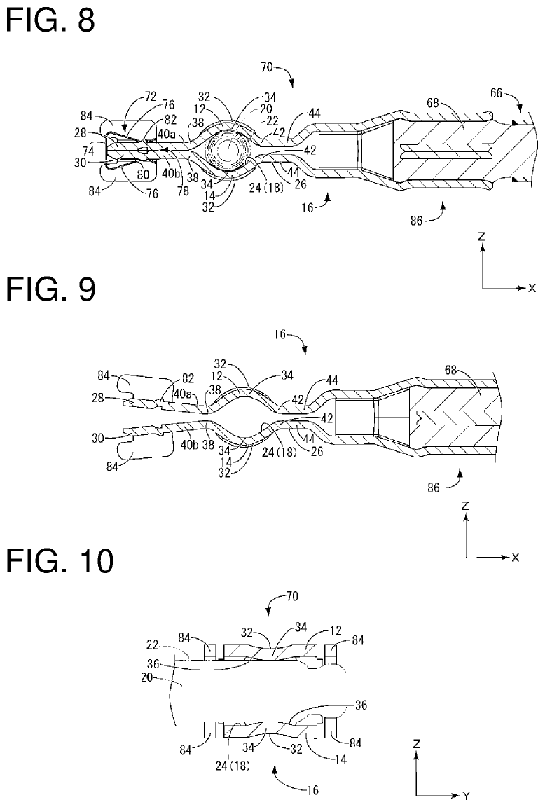

Lock claws 82 having a substantially triangular cross-sectional shape are respectively provided to project outward on the upper surface of an overlapping plate portion 40a and the lower surface of an overlapping plate portion 40b in central parts of the pair of overlapping plate portions 40a, 40b. Further, a pair of protection wall portions 84, 84 substantially in the form of rectangular flat plates are provided by bending both widthwise side end parts upward, which is opposite to an overlapping direction, on a tip part (left side in FIG. 8) in a projecting direction of the overlapping plate portion 40a. Further, a pair of protection wall portions 84, 84 similarly substantially in the form of rectangular flat plates are provided by bending both widthwise side end parts downward, which is opposite to an overlapping direction, on a tip part (left side in FIG. 8) in a projecting direction of the overlapping plate portion 40b. Moreover, extending end parts of a pair of extending plate portions 44, 44 are connected to a wire connecting portion 86. In the wire connecting portion 86, a core 68 of a wire 66 is conductively connected using a known crimping technique.

The clip 72 is press-fit to tip parts (left side in FIG. 8) in a projecting direction of the pair of overlapping plate portions 40a, 40b of a female terminal fitting 16 through an insertion opening 78. At this time, the pair of sandwiching plate portions 76, 76 are resiliently deformed in directions separating from each other, thereby riding over the lock claws 82 provided on the pair of overlapping plate portions 40a, 40b. Thereafter, the pair of sandwiching plate portions 76, 76 resiliently return, whereby the lock claws 82 are fit into lock holes 82 provided in the pair of sandwiching plate portions 76, 76 and the clip 72 is inseparably held on the female terminal fitting 16. As compared to the first embodiment, the clip 72 can be held on the pair of overlapping plate portions 40a, 40b of the female terminal fitting 16 by a simple structure of fitting the lock claws 82 into the lock holes 80. In this way, the structure of the clip 72 serving as the biasing means can be simplified and the female terminal 10 can be reduced in size. As a result, the tip parts in the projecting direction of the pair of overlapping plate portions 40a, 40b are sandwiched between the pair of sandwiching plate portions 76, 76 of the clip 72. Further, the pair of overlapping plate portions 40a, 40b are biased to be overlapped each other between the pair of sandwiching plate portions 76, 76 by resilient restoring forces of the pair of sandwiching plate portions 76, 76. Further, both widthwise sides of the pair of sandwiching plate portions 76, 76 of the clip 72 are protected by the pairs of protection wall portions 84, 84. Furthermore, the pairs of protection wall portions 84, 84 can function as guides in mounting the clip 72 on the pair of overlapping plate portions 40a, 40b.

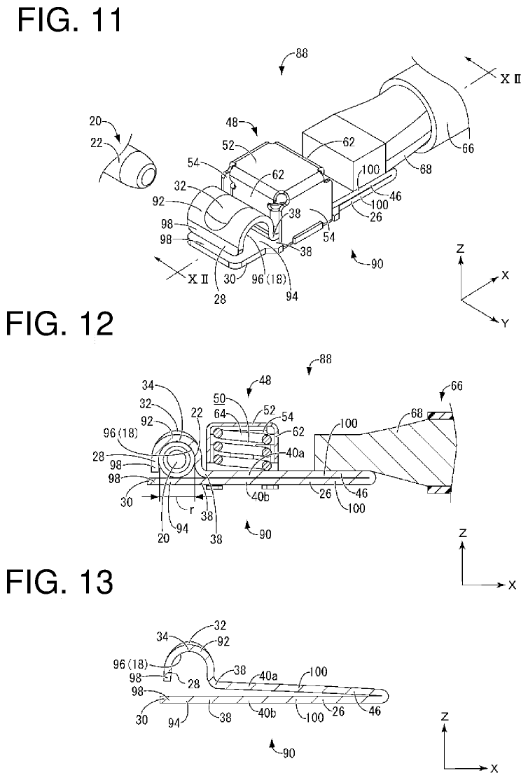

(2) Although the coil spring 64 or clip 72 serving as the biasing means is mounted on the tip side in the length direction (e.g. left end side in FIGS. 4 and 8) of the female terminal fitting 16 and the wire connecting portion 46, 86 is provided on a base end side in the length direction (e.g. right end side in FIGS. 4 and 8) in the above first and second embodiments, there is no limitation to this. As in a female terminal 88 of a third embodiment of the present disclosure shown in FIGS. 11 to 13, a female terminal fitting 90 may be configured such that a tubular connecting portion 96 formed by inner surfaces 18 of a first peripheral wall portion 92 and a second peripheral wall portion 94 is provided on a tip side, which is one end side in a length direction, a coil 64 or clip 72 serving as a biasing means is mounted in a lengthwise central part, and a wire connecting portion 46 is provided on a base end side, which is the other end side in the length direction. Also in the third embodiment, the tubular connecting portion 96 and the wire connecting portion 46 are integrally provided on the female terminal fitting 90 as in the above first and second embodiments, and the number of components of a female terminal 88 can be reduced. Further, since the coil spring 64 serving as the biasing means is also held on the female terminal fitting 90, a pressure contact force between the female terminal 88 and a male terminal 20 can be stably provided while the handleability of the female terminal 88 is improved. Moreover, as in the third embodiment, only one of the first and second peripheral wall portions 92, 94 may have an arcuate inner surface 18 and an arcuate protrusion 34 may be provided to project only on the first peripheral wall portion 92. Further, in the third embodiment, the female terminal fitting 90 is provided with a pair of overlapping plate portions 40a, 40b connected to a pair of first peripheral end parts 38, 38 and projecting outward (rightward in FIG. 12), and the coil spring 64 accommodated in a case 48 is disposed and held on the pair of overlapping plate portions 40a, 40b. The female terminal fitting 90 further includes a pair of extending plate portions 100, 100 extending further outward (rightward in FIG. 12) from projecting end parts of the pair of overlapping plate portions 40a, 40b, and the pair of extending plate portions 100, 100 are overlapped each other and fixed to and integrated with each other, for example, when a core 68 of a wire 66 is welded to the wire connecting portion 46. Further, the female terminal fitting 90 is provided with a pair of second peripheral end parts 98, 98 extending over an entire length in an axial direction at another circumferential position of the wire connecting portion 24, and the pair of second peripheral end parts 98, 98 are both free ends. In this way, when the male terminal 20 is press-fit into the tubular connecting portion 24, the pair of second peripheral end parts 98, 98 are displaced in separating directions, whereby the tubular connecting portion 24 is resiliently deformed in a diameter expanding direction and the male terminal 20 is allowed to be press-fit into the tubular connecting portion 24. Thus, an insertion force of the male terminal 20 into the tubular connecting portion 24 can be advantageously reduced.

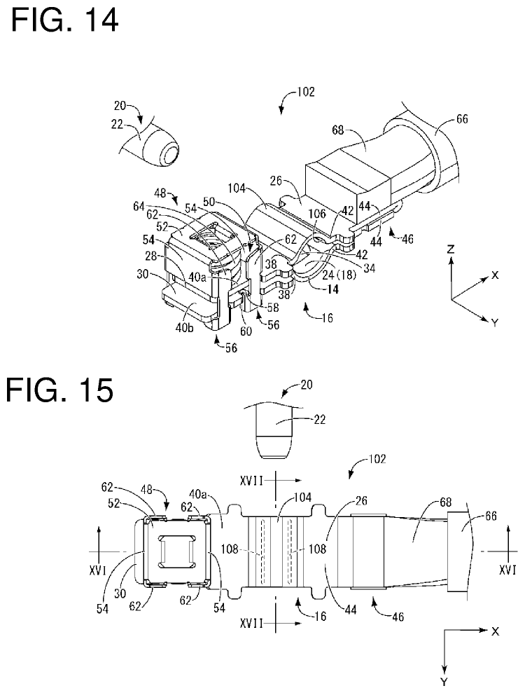

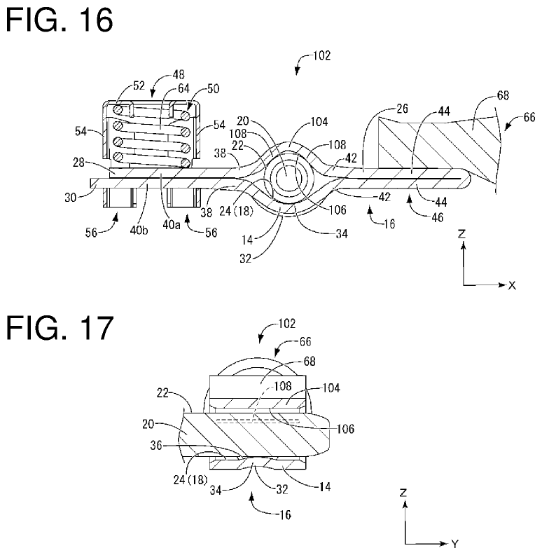

(3) Although the arcuate protrusions 34 are provided on the inner surfaces 18 of both the first and second peripheral wall portions 12, 14 in the above first and second embodiments, there is no limitation to this. As in a female terminal 102 of a fourth embodiment of the present disclosure shown in FIGS. 14 to 17, both a first peripheral wall portion 104 and a second peripheral wall portion 14 have an inner surface 106, 18 having an arcuate cross-section, an arcuate protrusion 34 may be provided on the inner surface 18 of the second peripheral wall portion 14, and linear connecting portions 108 projecting radially inward while extending in an axial direction (direction perpendicular to the plane of FIG. 16) of the inner surface 106 may be provided at a plurality of positions (two positions in the fourth embodiment) separated in a circumferential direction on the inner surface 106 of the first peripheral wall portion 104. Here, a curvature of the inner surface 106 of the first peripheral wall portion 104 is set smaller than that of the outer peripheral surface of a cylindrical connecting portion 22 of a male terminal 20. In this way, the linear connecting portions 108 at two positions can be reliably brought into contact with the cylindrical connecting portion 22 of the male terminal 20. Since the linear connecting portions 108 are pressed into line contact with the cylindrical connecting portion 22 of the male terminal 20 at the two positions separated in the circumferential direction in this way, even if a swinging motion is transmitted to the male terminal 20 from an unillustrated wire, a displacement of the male terminal 20 caused by the swinging motion can be hindered by the contact of the male terminal 20 with the linear connecting portions 108 at the two positions. Therefore, a displacement of the male terminal 20 caused by a swinging motion can be hindered by the linear connecting portions 108 at the two positions of the first peripheral wall portion 104 while the arcuate protrusion 34 of the second peripheral wall portion 14 is pressed into contact with a wide range of the outer peripheral surface of the cylindrical connecting portion 22 of the male terminal 20 with a higher contact pressure. As a result, both an increase in contact area with the male terminal 20 and stable holding of the male terminal 20 can be achieved.

Note that although the arcuate protrusion 34 is provided on the inner surface 18 of the second peripheral wall portion 14 in the above fourth embodiment, a plurality of linear connecting portions 108 may be provided in regions separated in the axial direction from the arcuate protrusion 34 in addition to the arcuate protrusion 34. Further, although the two linear connecting portions 108 are provided on the inner surface 106 of the first peripheral wall portion 104 in the fourth embodiment, three or more linear connecting portions 108 may be provided or an arcuate protrusion 34 may be provided in a region separated in the axial direction from the linear connecting portions 108 in addition to the linear connecting portions 108. Moreover, the curvature of the inner surface 106 of the first peripheral wall portion 104 needs not necessarily be set smaller than that of the outer peripheral surface of the cylindrical connecting portion 22 of the male terminal 20 if the contact of the linear connecting portions 108 with the cylindrical connecting portion 22 is ensured. By forming the first peripheral wall portion 104 to have an inner surface having a polygonal cross-sectional shape, a plurality of linear connecting portions 108 separated in the circumferential direction may be provided.

(4) Although the circumferential position of the first peripheral wall portion 12, 92 and 104 is a position facing the second peripheral wall portion 14, 94 in the circumferential direction in the above first, second, third and fourth embodiments, there is no limitation to this. This circumferential position can be arbitrarily set depending on conditions such as an arrangement region of the female terminal. For example, the first and second peripheral wall portions may be provided at positions separated by 90° in the circumferential direction and the overlapping plate portions 40a, 40b and the extending plate portions 44 may be configured to project in directions orthogonal to each other.

(5) Although the wire 66 fixed to the wire connecting portion 46, 86 extends in the direction orthogonal to the axial direction of the tubular connecting portion 24, 96 in the above first, second, third and fourth embodiments, the wire 66 may be fixed to the wire connecting portion 46, 86 to extend in the axial direction of the tubular connecting portion 24, 96.

(6) Although a connecting portion of the male terminal 20 is the cylindrical connecting portion 22 in the above first, second, third and fourth embodiments, there is no limitation to this. Even if a columnar connecting portion of a male terminal to be inserted has an elliptical, polygonal or rectangular cross-sectional shape, effects of stably securing a contact area between male and female terminals and setting a pressure contact force with a high degree of freedom can be enjoyed.

(7) Although the arcuate protrusion 34 facing the male terminal insertion opening side of the tubular connecting portion 24, 96 has an arcuate cross-section and, thereby, the both side surfaces 36, 36 of the arcuate protrusion 34 also have an arcuate cross-section in the above first, second, third and fourth embodiments, there is no limitation to this. That is, only one side surface 36 of the arcuate protrusion 34 on a male terminal insertion side may have an arcuate cross-section. Further, only the both side surfaces 36, 36 may have an arcuate cross-section and a projecting upper surface part may be, for example, formed by a flat surface or the like.

### LIST OF REFERENCE NUMERALS

10 female terminal (first embodiment)
12 first peripheral wall portion
14 second peripheral wall portion
16 female terminal fitting
18 inner surface
20 male terminal
22 cylindrical connecting portion
24 tubular connecting portion
26 metal flat plate
28 one end part
30 another end part
32 recess
34 arcuate protrusion
36 side surface
38 first peripheral end part
40a, 40b overlapping plate portion
42 second peripheral end part
44 extending plate portion
46 wire connecting portion
48 case
50 accommodation space
52 facing wall
54 wall portion
56 engaging frame body
58 engaging recess
60 engaging projection
62 coil spring holding wall
64 coil spring (biasing means)
66 wire
68 core
70 female terminal (second embodiment)
72 clip (biasing means)
74 coupling plate portion
76 sandwiching plate portion
78 insertion opening
80 lock hole
82 lock claw
84 protection wall portion
86 wire connecting portion
88 female terminal (third embodiment)
90 female terminal fitting
92 first peripheral wall portion
94 second peripheral wall portion
96 tubular connecting portion
98 second peripheral end part
100 extending plate portion
102 female terminal (fourth embodiment)
104 first peripheral wall portion
106 inner surface
108 linear connecting portion

1. A female terminal, comprising:
a tubular connecting portion including a first peripheral wall portion and a second peripheral wall portion arranged to face each other, the tubular connecting portion being conductively connected to a columnar connecting portion of a male terminal;
a biasing means for biasing the first and second peripheral wall portions in directions approaching each other; and
an arcuate protrusion provided on an inner surface having an arcuate cross-section of at least one of the first and second peripheral wall portions, the arcuate protrusion projecting radially inward while extending in a circumferential direction of the inner surface,
wherein:
the first and second peripheral wall portions are separably displaceable against a biasing force of the biasing means,
both the first and second peripheral wall portions have the inner surface having the arcuate cross-section,
the arcuate protrusion is provided on the inner surface of one of the first and second peripheral wall portions, and
linear connecting portions projecting radially inward while extending in an axial direction of the inner surface are provided at a plurality of positions separated in the circumferential direction on the inner surface of the other of the first and second peripheral wall portions.

2. (canceled)

3. (canceled)

4. A female terminal according to claim 1, wherein a curvature of the other of the first and second peripheral wall portions is set smaller than that of an outer peripheral surface of the columnar connecting portion of the male terminal.

5. A female terminal according to claim 1, wherein the arcuate protrusion extends in the circumferential direction to have a circumferential length of ⅔ or more of a circumferential length of the inner surface.

6. A female terminal according to claim 1, wherein a side surface of the arcuate protrusion facing a male terminal insertion opening side of the tubular connecting portion has an arcuate cross-section.

7. A female terminal according to claim 1, wherein:
a pair of overlapping plate portions separated from each other and projecting outward are respectively connected to a pair of mutually facing peripheral end parts of the first and second peripheral wall portions, and
the biasing means biases the pair of overlapping plate portions in directions to overlap the overlapping plate portions each other, whereby the first and second peripheral wall portions are biased in directions approaching each other.

8. A female terminal according to claim 1, further comprising a female terminal fitting including the tubular connecting portion on one end side and a wire connecting portion on the other end side, wherein the biasing means is held on the female terminal fitting.
